(19) United States
(12) Patent Application Publication
(10) Pub. No.: US 2003/0128432 A1
(43) Pub. Date: Jul. 10, 2003

(54) Polarization independent thin film optical interference filters

(76) Inventors: Robert H. Cormack, Decatur, GA (US); David A. Goldberg, Boulder, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 10/228,201

(22) Filed: Aug. 26, 2002

Related U.S. Application Data
(60) Provisional application No. 60/324,168, filed on Sep. 21, 2001.
(60) Provisional application No. 60/344,312, filed on Dec. 20, 2001.
(60) Provisional application No. 60/379,888, filed on May 13, 2002.

(51) Int. Cl. G02B 27/00

(52) U.S. Cl. 359/577

(57) ABSTRACT

Design and construction of polarization-independent thin film interference filters is accomplished by applying at least one of the following design rules to an original filter design including quarter wave stacks (QWS) of layers of alternating higher index material (H) and lower index material (L) and half wave cavities (HWC): design rule 1—increasing or decreasing the thicknesses of HWC's in the filter by a small (less than ¼ wavelength) increment; design rule 2—adding small increments (less than ¼ wavelength) to one or more layers and correspondingly subtracting equivalent aggregate increments from one or more adjacent or nearby layers; or design rule 3—replacing HWC's with asymmetric composite HWC's.

### BACKGROUND OF THE INVENTION

This application claims priority to the following provisional patent applications and incorporates them herein by reference: Ser. No. 60/324,168, filed Sep. 21, 2001; Ser. No. 60/344,312, filed Dec. 20, 2001; and Ser. No. 60/379,888, filed May 13, 2002.

### FIELD OF THE INVENTION

The present invention relates to the design and construction of thin film interference filters, and particularly to filters that are polarization independent.

### DESCRIPTION OF THE PRIOR ART

Multiple layer thin film optical interference filters are a relative mature technology, in that higher order optical bandpass functions can be tailored at will to diverse applications. Examples are various beamsplitter types, fluorescent microscopy filters, narrow bandpass telecom filters, and telecom gain equalization filters. Most thin film interference filters (TFFs) are used so that the normal vector to the filter surface is nearly parallel (at 0 degrees) to the incident light (designated 0° incidence, or normal incidence). At normal and near-normal incidence, these filters have no significant polarization sensitivity.

At higher angles of incidence, the S-polarized light will, in general, see a different bandpass function than the P-polarized light. A few TFF applications, such as beamsplitters, are designed to be used at high incidence angles, such as 45°. In these filters, the polarization sensitivity must be taken into account and either designed out, as in amplitude beamsplitters and dichroic beamsplitters, or exploited as in polarization beamsplitters.

It has long been known that properly designed TFFs can be tuned in wavelength by adjusting the incidence angle of the light. This tuning effect is limited to about 5% of the center wavelength, however, so that the application of TFFs as tunable filters has been limited. For Dense Wavelength Division Multiplexed (DWDM) fiber networks, however, this is not a serious limitation—5% of 1550 nm, for example, is nearly 80 nm, which would easily cover a DWDM band. Since optical fiber networks are not currently polarization-maintaining, the polarization sensitivity of TFFs must be taken into account, either in the design of the TFF, or the optical system surrounding it.

Coupled Fabry-Perot Filter Design:

The standard design for a narrow bandpass DWDM filter is a coupled Fabre-Perot design, which consists of multiple Half-Wave-Cavities (HWC) separated by Quarter-Wave-Stacks (QWS), which act as mirrors. For example a generic (three-cavity) DWDM bandpass design deposited on glass substrate could be:

Air {(HL)ⁿ H} [(2m)L] {(HL)⁽²ⁿ⁺¹⁾ H} [(2m)L] {(HL)⁽²ⁿ⁺¹⁾ H} [(2m)L] {(HL)ⁿ H} glass

In this formula;

1. L and H represent a quarter-wave thickness of the Low and High index materials respectively;

2. n and m are any integers;

3. The expression, (HL)ⁿ, represents the layers H & L repeated n times—for example, (HL)³=HLHLHL;

4. The expressions, qL or qH, (where q is any number) represents single L and H layers that are q times ¼ wave thick;

5. And the quantities in curly brackets are Quarter-Wave-Stacks while the quantities in square brackets are Half-Wave-Cavities.

From point 5), above, an alternate way to symbolize this filter could be:

Air {QWS₁} [HWC₁] {QWS₂} [HWC₂] {QWS₃} [HWC₃] {QWS₄} Glass.

Conventional variations of this generic filter include: using more or fewer numbers of HWC's, changing the relative lengths of the QWS's, and including “coupling” layers (non-quarter-wave thick layers) at the ends of the filter (or sometimes within the QWS's) in order to achieve better throughput or filter bandpass shape.

Monitoring Filter Deposition:

Channel filters for DWDM fiber networks typically have extremely narrow bandpasses—as little as a few hundredths of a percent of the center wavelength of the filter. Thin-film interference filters (TFF's) that meet these requirements often have over 100 layers. Modeling of these filters reveals that the maximum practical tolerance for random error in the individual layer thickness of these TFF's is of the order of 0.01%. However, state-of-the-art vacuum deposition techniques (how the vast majority of TFF's are fabricated) have a typical random error of 1% for the individual layer thickness. Thus the fabrication error is 100 times the allowable error!

The day is saved by use of interferometric monitoring systems: these systems pass light through the filter as the layers are built up in the vacuum system. The signal from this monitor goes through a maximum or minimum each time the total thickness of the filter increases by one-quarter wavelength.

If layer transitions are done at these maximums and minimums, then the resulting errors are no longer random, but are correlated: If one layer is too thick, then the next layer is automatically biased to be too thin. This self-correcting tendency, plus the robustness of the coupled Fabre-Perot structure is what allows ultra narrow-band TFF's to be successfully manufactured with today's thin-film fabrication equipment.

For high-incidence applications such as beamsplitters, the polarization characteristics of the filter can be controlled to a large degree by adjusting the design of the individual layers. In practice, a computer program is used to vary the layer thicknesses randomly (or according to some devised pattern) until the desired polarization characteristics are achieved. This technique results in constructable filters as long as the number of layers is such that 1% thickness errors are acceptable.

FIGS. 1A-1C (Prior Art) are diagrams illustrating the layers of a narrow bandpass telecom thin film interference filter, composed of alternating Quarter Wave Stacks (QWS) and Half Wave Cavities (HWC). FIG. 1A shows quarter wave stack 100. QWS's are composed of alternating high index material quarter wave layers 102 and low index material quarter wave layers 104, in this example silicon dioxide (SiO₂) and Tantalum pentoxide (Ta₂O₅). Each of the layers 102 and 104 is one quarter wavelength thick, (λ/4), where the wavelength λ is the wavelength at the desired center of the bandpass at normal incidence, measured inside the material.

FIG. 1B (Prior Art) is a diagram of two QWS's 100 combined with a Half-Wave Cavity (HWC) layer 110 to form a narrow bandpass filter. A HWC layer 110 is a layer of either the high or low index material that is an integral number of half wavelengths thick; HWC=(2L)ⁿ or (2H)ⁿ, where n is a positive while number. This single cavity filter is equivalent to a Fabry-Perot filter with partially reflecting mirrors equal to the reflectivity of the QWS's 100. For the center wavelength (where the cavity is an integer number of half wavelengths thick), the reflection from the second QWS 100 (on the far side of the cavity) is 180° out of phase with the reflection from the first QWS 100, and (after the transient response settles) the two reflections cancel, and the desired wavelength is transmitted through the filter. For highly reflective QWS's 100, the cancellation is nearly complete only very close to the design wavelength and fails at slightly longer or shorter wavelengths—hence the filter transmits the design wavelength and reflects others.

FIG. 1C (Prior Art) is a diagram showing several single cavity filters that are combined into a multiple cavity filter 120. The number of layers in the QWS's 100 can be adjusted to manipulate the bandpass shape—and a wide range of shapes can be achieved. For telecom use, narrow flat topped bandpasses with steep skirts are of particular interest for separating out channels from Dense Wavelength Division Multiplexed (DWDM) fiber networks.

FIG. 2 (Prior Art) is a plot of the bandpass of a TFF that is angle tuned away from the central wavelength of a multiple cavity polarization-dependent filter. The thin film telecom filter is placed at an incidence angle of 22° to the input light. At this angle, the bandpasses for S-polarized light (in solid line) and P-polarized light (in dotted line) no longer substantially overlap. This filter could not be used in a WDM system (at this angle of incidence) without using an optical system to convert the input light to a single polarization.

TFF's can be designed with nearly arbitrary polarization effects:

Polarizing and Nonpolarizing beam-splitters (both built with 10-30 layer TFF's) have opposite polarization characteristics, for example. However, these designs all require numerous layers of arbitrary thickness and thus are not compatible with the interferometric monitoring system necessary for successfully building ultra narrowband bandpass filters for DWDM.

It is also known in the art to replace half wave cavities (HWCs) with symmetric composite cavities (such as, for example, 4L 24H 4L) or to add a HWC thickness to the quarter wave plates in the quarter wave stack. See, for example, U.S. Pat. No. 5,926,317 to Cushing. These design methods are achievable with interferometric monitoring system usage, but suffer from other disadvantages. Thicker HWCs result in smaller free spectral range for the filter. Adding a HWC thickness to the quarter wave plates in the quarter wave stacks makes the entire filter considerably thicker, which makes it harder to manufacture and subject to greater curvature and strains.

A need remains in the art for designs and methods of design of polarization-independent thin film filters which can be accurately fabricated.

### SUMMARY

It is an object of the present invention to provide designs and methods of design of polarization-independent thin film filters which can be accurately fabricated. This object is accomplished by providing designs and design methods which vary the polarization response of the filter in ways that still allow the filter to be fabricated using interferometric monitoring systems.

Several specific methods are shown for modifying standard (coupled Fabre-Perot) narrow-bandpass DWDM filters in ways that affect the polarization properties of such filters while still allowing the effective use of interferometer monitoring during filter fabrication:

Method 1. Add (or subtract) a small increment of thickness to each HWC in a filter, equally.

This is equivalent to designing the HWC to have a slightly different resonant wavelength then the surrounding QWS's.

This change directly affects the relative rate at which the S and P-polarization bandpasses angle-tune. To achieve the goal of having the S and P bandpasses tune together with increasing AOI, a low-index HWC is made to be resonant at longer wavelength than the QWS, and a high-index HWC is made to be resonant at a shorter wavelength than the QWS.

Method 2. Add (or subtract) a small (less than ¼ wavelength) increment of thickness to a layer, then subtract (or add) the same increment from an adjacent or nearby layer.

2a) This technique can be applied to a QWS as follows:

{. . . L H L H . . . } −>{. . . (L+Δ) (H−Δ) (L+Δ) (H−Δ) . . . }

or

{. . . L H L H . . . } _{. . . (L−Δ) (H+Δ) (L−Δ) (H+Δ) . . . }

where Δ is the small increment of thickness.

2b) This technique can also be used to modify a HWC like the following:

. . . L H [2mL] H L . . . −>. . . L H [2mL+Δ] (H−Δ) L . . .

. . . H L [2mH] L H . . . −>. . . H L [2mH+Δ] (L−Δ) H . . .

As a variation of this method, the increment and/or its correcting anti-increment may be distributed between more than 2 layers as follows:

. . . (nL+α)(mH−β)(pL+δ) . . . ,

where α, β,δ are small (negative or positive) increments of thickness such that:

α+δ=β, (where β is also allowed to be zero)

2c) This method involves adding an increment to one or more layers of a HWC, then subtracting the same aggregate increment from one or more layers of the HWC. An example, where this method is applied to the layers at the edges of a HWC is:

. . . H L (2H−Δ) [2mL] (2H+Δ) L H . . .

an asymmetric composite HWC example is:

. . . (2H+Δ)(2L−Δ)

where Δ is a positive or negative increment of thickness. The method will still work if there is more than one intervening layer, but there is generally no advantage to doing so.

In general, the various embodiments of method (2) allow the S and P polarization bandpass tuning rates to be usefully controlled when they are either applied to an entire QWS, or to all HWC's in the filter.

Method 3. Replace the uniform and/or symmetric HWC's with asymmetric, composite HWC's. Composite HWC's can cause the S and P polarizations to become coincident. Making the composite HWC's asymmetric often means that the HWC's can be much smaller than those resulting from symmetric designs. As smaller HWC's result in larger free spectral ranges, this is an advantage.

An example of a filter incorporating this design rule is:

. . . (HL)^{m}(2nH 2pL)(LH)^{q} . . .

Where m, n, p, and q are integers.

The various types of filter design modifications (methods (1), (2a), (2b), (2c) and 3) described above can be used singly or in any combination in order to control the polarization characteristics of thin-film interference filters without upsetting the use of an interferometric monitoring system—hence keeping the crucial error correlations necessary to successfully build ultra narrow-bandpass filters for DWDM network use.

The basic filter design modification algorithm is iterative:

Start with filter design which meets normal incidence requirements, but has unacceptable polarization characteristics at higher angles of incidence (AOI).

Modify filter design with some combination of design modification types (1), (2a), (2b), (2c) and 3. If the resulting design is acceptable, stop. If not, modify again, and so on.

The modifying step can use any known optimization methods of generating new design modifications including; exhaustive search, gradient descent, simulated annealing, genetic algorithms, or any other method known to the art.

### BRIEF DESCRIPTION OF THE DRAWINGS

FIG. 1A (Prior Art) is a schematic diagram of a quarter wave stack.

FIG. 1B (Prior Art) is a schematic diagram of two QWS's 100 combined with a Half Wave Cavity (HWC) layer 110 to form a narrow bandpass filter.

FIG. 1C (Prior Art) is a schematic diagram of several single cavity filters that are combined into a multiple cavity filter.

FIG. 2 (Prior Art) is a plot of the bandpass of a thin film filter that is angle-tuned away from the central wavelength of a multiple cavity polarization dependent filter of prior art.

FIG. 3 is diagram illustrating a filter design having cavities modified according to method (1) of the present invention.

FIG. 4 is a plot of the bandpass of the thin film of FIG. 3.

FIG. 5 is diagram illustrating a filter design with quarter wave stacks modified according to method (2a) of the present invention.

FIG. 6 is a plot of the bandpass of the thin film of FIG. 5.

FIG. 7 is diagram illustrating a filter design having cavities modified according to method (2b) of the present invention.

FIG. 8 is a plot of the bandpass of the thin film of FIG. 7.

FIG. 9 is a flow diagram illustrating the iterative design method for designing polarization-independent thin film filters according to the present invention.

FIG. 10 is a plot of the bandpass of a first thin film filter incorporating an asymmetric partitioned cavity according to method 3.

FIG. 11 is a plot of the bandpass of a second thin film filter incorporating an asymmetric partitioned cavity according to method 3.

FIG. 12 is a plot of the bandpass of a third thin film filter incorporating an asymmetric partitioned cavity according to method 3, and further including a design modification to the cavity according to method 2(b).

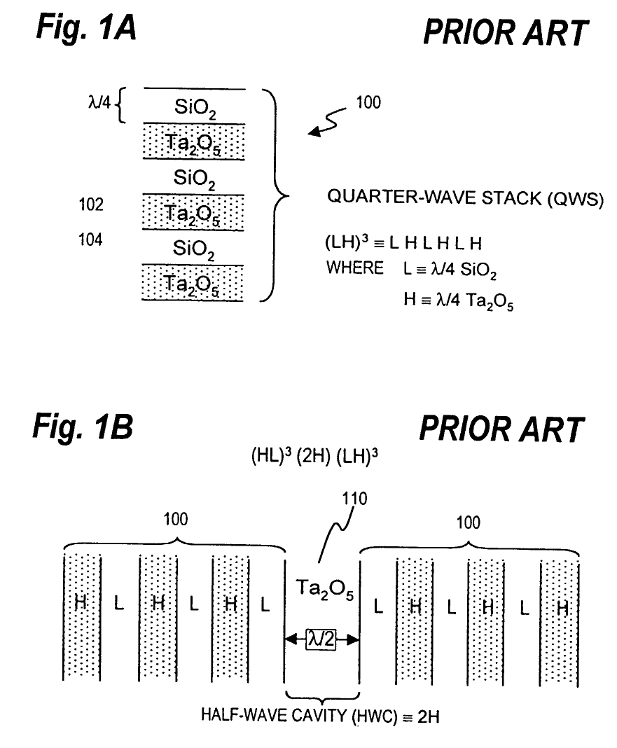

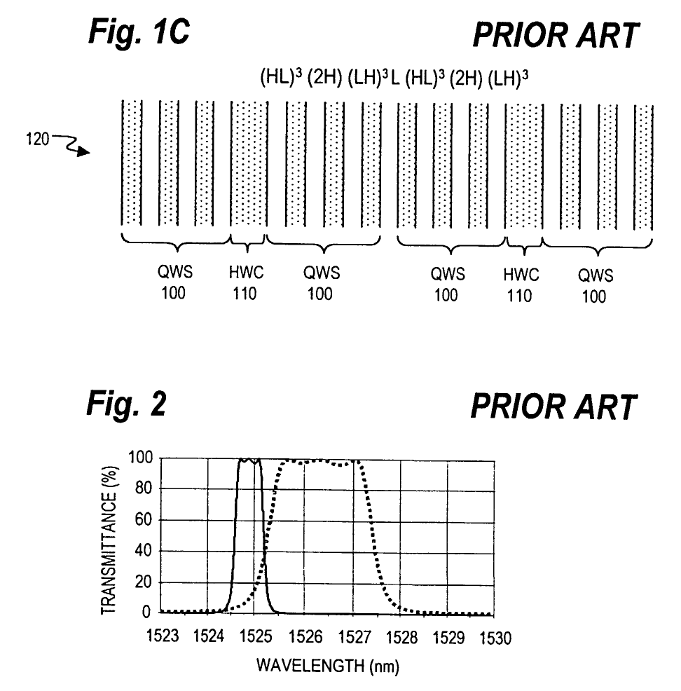

### DETAILED DESCRIPTION OF THE PREFERRED EMBODIMENTS:

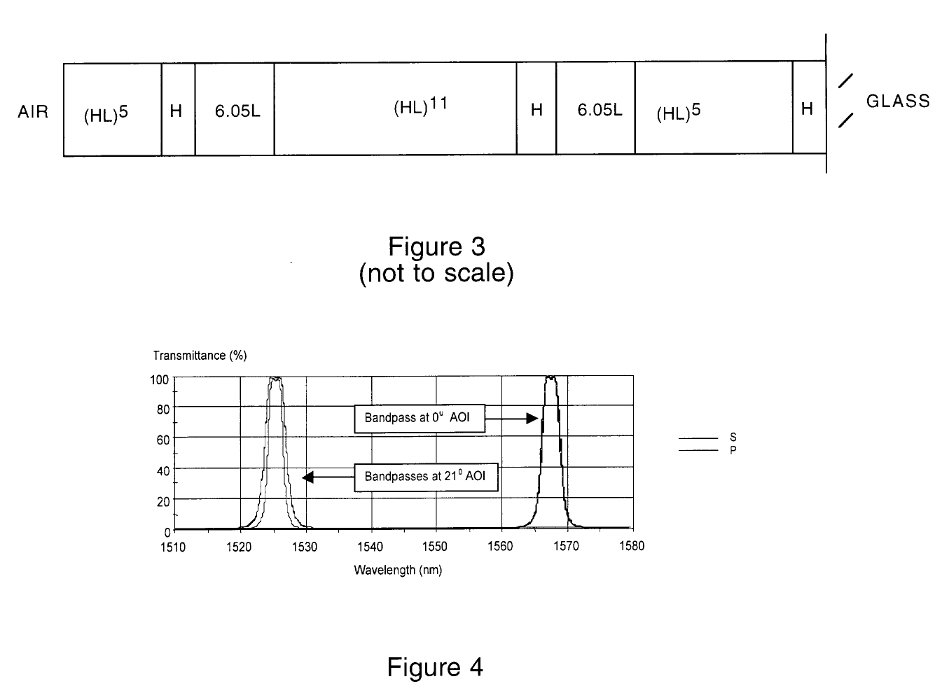

FIG. 3 is diagram illustrating a filter design according to method (1) of the present invention. Method (1) is as follows:

Method (1): Add (or subtract) a small increment of thickness to each HWC in a filter, equally.

L H [2mL] H L . . . −>. . . L H [2mL+Δ] H L . . . or

L H [2mL] H L . . . −>. . . L H [2mL−Δ] H L . . .

for all HWC in the filter.

This is equivalent to designing the HWC to have a slightly different resonant wavelength then the surrounding QWS's.

This change directly affects the relative rate at which the S and P-polarization bandpasses angle-tune. To achieve the goal of having the S and P bandpasses tune together with increasing AOI, a low-index HWC is made to be resonant at longer wavelength than the QWS, and a high-index HWC is made to be resonant at a shorter wavelength than the QWS.

In the example of FIG. 3, the filter prescription is:

AIR I (HL)⁵H(6.05L)(HL)¹¹H (6.05L)(HL)⁵ H I GLASS

Where:

L=λ/4 of SiO₂

H=λ/4 of Ta₂O₅

λ=1525 nm ?

And the HWC are cavities at a wavelength that is 0.83% of the wavelength the QWS's are designed for.

FIG. 4 is a plot of the bandpass of the thin film of FIG. 3. The right hand plot shows the filter at 0° incidence, and the left hand plot shows the filter tuned by to a 21° angle of incidence. The P-polarization bandpass is slightly wider than the S-polarization bandpass, but they are centered at the same place and have a large area of overlap.

Design rule (1) may also be implemented by slightly shortening high-index cavities. An example filter prescription is:

AIR I (HL)⁵H(5.95L)(LH)¹⁰L (5.95H)(LH)⁵ I GLASS

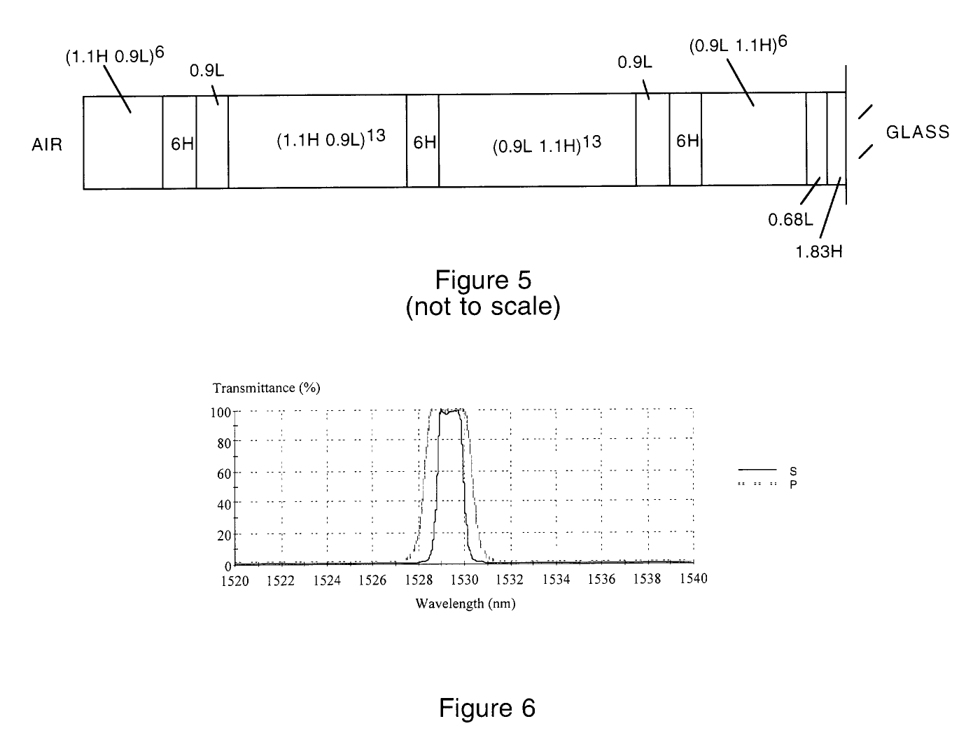

FIG. 5 is diagram illustrating a filter design according to method (2a) of the present invention. Method (2a) is as follows:

Method (2a). Add (or subtract) a small (less than ¼ wavelength) increment of thickness to a layer, then subtract (or add) the same increment from an adjacent or nearby layer.

2a) This technique can be applied to a QWS as follows:

{. . . L H L H . . . } −>{. . . (L+Δ) (H−Δ) (L+Δ) (H−Δ) . . . }

or

{. . . L H L H . . . } _{. . . (L−Δ) (H+Δ) (L−Δ) (H+Δ) . . . }

where Δ is the small increment of thickness.

In the example of FIG. 5, the filter prescription is:

AIR I (1.1H 0.9L)⁶ (6H) 0.9L (1.1H 0.9L)¹³ (6H) (0.9L 1.1H)¹³ 0.9L (6H) (0.9L 1.1H)⁶ 0.68L 1.83 H I GLASS

Where:

L=λ/4 of SiO₂

H=λ/4 of Ta₂O₅

λ=1582 nm

And Δ=0.1 quarter waves

Note that the layers adjacent to the glass (0.68L 1.83 H) are coupling layers. Coupling layers are not indicated in every embodiment herein, as they are well understood by those skilled in the art of filter design.

FIG. 6 is a plot of the bandpass of the thin film of FIG. 5. The filter is tuned by 50 nm (25° angle of incidence). Again, the P-polarization bandpass is wider than the S-polarization bandpass, but they are centered at almost the same place and have a large area of overlap.

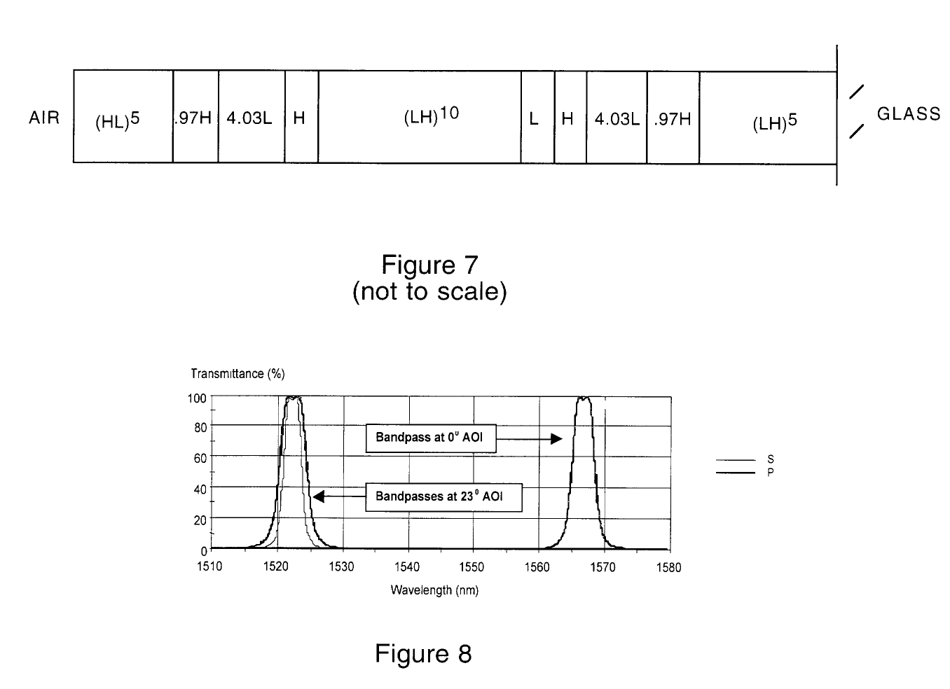

FIG. 7 is diagram illustrating a filter design according to method (2b) of the present invention. Method (2b) is as follows:

Method (2b): This technique modifies a HWC like the following:

. . . L H [2mL] H L . . . −>. . . L H [2mL+Δ] (H−Δ) L . . .

or

. . . H L [2mH] L H . . . −>. . . H L [2mH+Δ] (L−Δ) H . . .

Recall that interferometric monitoring systems are used to monitor thin film manufacturing. These systems pass light through the filter as the layers are built up in the vacuum system. The signal from this monitor goes through a maximum or minimum each time the total thickness of the filter increases by one-quarter wavelength, and these maxima/minima are the “monitor points”. This method is even better than method 1, because the compensation means that the peak/valley monitor points are returned to the appropriate locations.

In the example of FIG. 7, the filter prescription is:

AIR I (HL)⁵ (0.97 H)(4.03L) H (LH)¹⁰ LH (4.03L)(0.97 H) (LH)⁵ I GLASS

Where:

L=λ/4 of SiO₂

H=λ/4 of Ta₂O₅

λ=1582 nm

And Δ=0.1 quarter waves

FIG. 8 is a plot of the bandpass of the thin film of FIG. 7. The filter is tuned by 45 nm (23° angle of incidence). Again, the P-polarization bandpass is slightly wider than the S-polarization bandpass, but they are centered at almost the same place and have a large area of overlap.

A number of variations on the filter of FIGS. 7 and 8 give equivalent results. For example:

AIR I (HL)⁵ H(4.03L)(0.97H) (LH)¹⁰ L (0.97 H) (4.03L) H (LH)⁵ I GLASS;

AIR I (HL)⁵ (0.99H)(4.03L)(0.98H) (LH)¹⁰ L (0.98 H) (4.03L) (0.99H) (LH)⁵ I GLASS;

etc.

A generalized formula for this filter is:

AIR I (HL)⁵ (1−A)H(4+X)L(1−B)H (LH)¹⁰ L (1−C) H (4L+X) L (1−D) H (LH)⁵ I GLASS

where A+B=X=C+D

An even more generalized filter formula for a filter of this type is:

AIR I (HL)ⁿ (1−A)H(2q+X)L(1−B)H (LH)^{m} L (1−C)H (2q+X)L (1−D)H (LH)^{p} I GLASS

where n, m, p, and q are integers.

If the filter of FIGS. 3 and 4 were modified according to rule 2a, the filter prescription might be:

AIR I (HL)⁴H (1.05L)(5.95H)(LH)¹⁰ L (5.95H)(1.05L) H (LH)⁴ I GLASS

Where X=−0.05, A=D=−0.05, and B=C=0.

FIG. 13 is a diagram illustrating a filter design according to method (2c) of the present invention. Method (2c) is as follows:

2c) Add an increment to one or more layers of a HWC, and subtract the same aggregate increment from one or more layers of the HWC. An example, where this method is applied to the layers at the edges of a HWC is:

. . . H L (2H−Δ) [2mL] (2H+Δ) L H . . .

an asymmetric composite HWC example is:

. . . (2H+Δ)(2L−Δ)

where Δ is a positive or negative increment of thickness.

In the example of FIG. 13, the filter prescription is:

AIR I (HL)⁷ H(2.02 L 1.97H 2.03L) H (LH)¹⁴ (2.02 L 1.97H 2.03L) H (LH)⁷ I GLASS

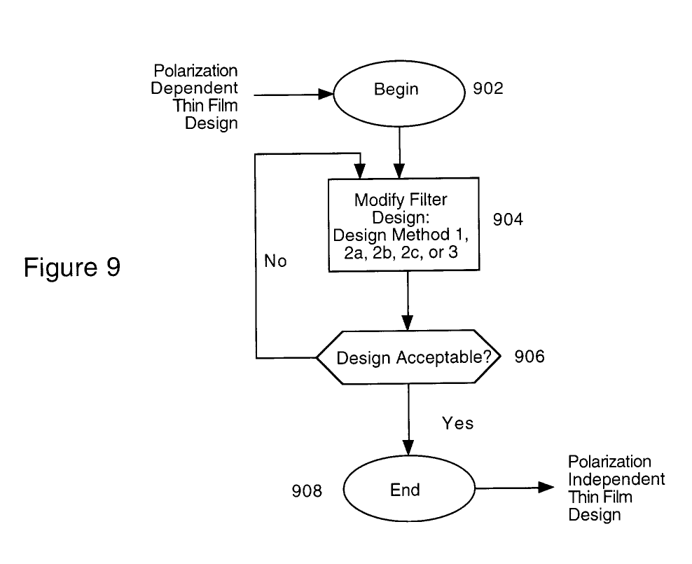

FIG. 9 is a flow diagram illustrating the iterative design method for designing polarization-independent thin film filters according to the present invention. The basic filter design modification algorithm is:

Start at step 902 with a filter design which meets normal incidence requirements, but has unacceptable polarization characteristics at higher angles of incidence (AOI). In step 904, modify the filter design with some combination of design modification rules 1, 2a, 2b, 2c, and 3. Step 906 tests whether the resulting filter's polarization characteristics at high AOI are acceptable. If No, then process returns to step 904. If Yes, process ends at step 908.

The iterative process of steps 904 and 906 can use any known optimization methods of generating new design modifications including;

exhaustive search, gradient descent, simulated annealing, genetic algorithms, or any other method known to the art.

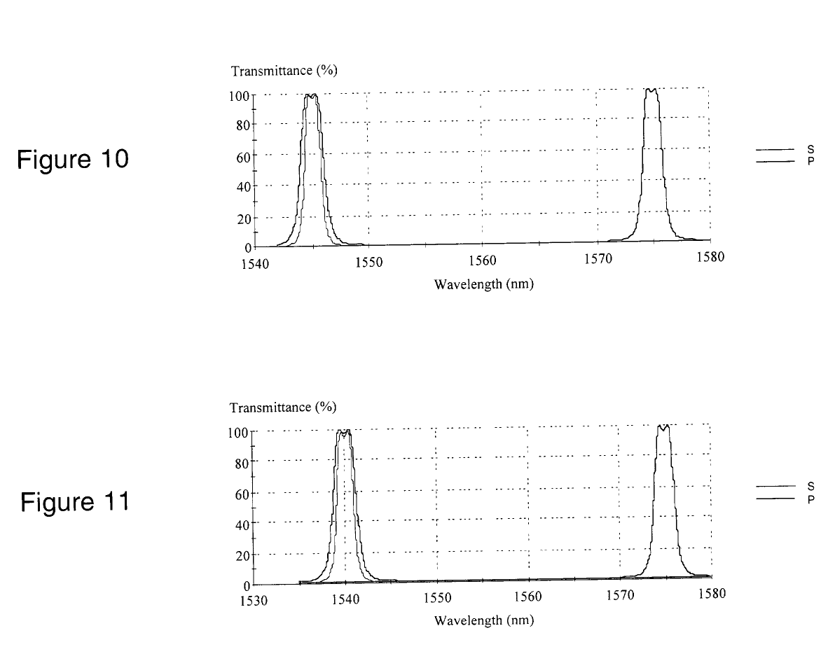

FIGS. 10-12 are plots illustrating thin film designs incorporating method (3) of the present invention. In each case the normal incident plot is on the right hand side, and the high incident angle (˜20°) plot is on the left hand side.

Method (3) is as follows:

Method 3. Replace the uniform and/or symmetric HWC's with asymmetric, composite HWC's. Composite HWC's can cause the S and P polarizations to become coincident. Making the composite HWC's asymmetric often means that the HWC's can be much smaller than those resulting from symmetric designs. As smaller HWC's result in larger free spectral ranges, this is an advantage.

An example of a filter incorporating this design rule is:

. . . (HL)^{m}(2nH 2pL)(LH)^{q} . . .

Where m, n, p, and q are integers.

FIG. 10 is a plot of the bandpass of a first thin film filter incorporating an asymmetric partitioned cavity according to method 3. The filter prescription is:

AIR I (HL)⁶ (5H 2L) (HL)¹³(5H 2L) (HL)⁶ H I GLASS

Note that the HWC's in this filter include an odd number of quarter wavelengths (5H 2L) rather than the usual even number. This is because the interface entering the HWC and the interface leaving the HWC are both L to H interfaces. Hence, an odd number of quarter wave layers is required in order to achieve positive interference within the HWC, since the reflections at the front and back of the cavity are now in phase.

FIG. 11 is a plot of the bandpass of a second thin film filter incorporating an asymmetric partitioned cavity according to method 3. The filter prescription is:

AIR I (HL)⁶ (2H 7L) (HL)⁶ (2H 7L) (HL)⁶ I GLASS

This plot illustrates that a thin film filter with asymmetric HWC's having an even number of H layers and an odd number of L layers is also effective. Note that the HWC's in this filter include an odd number of quarter wavelengths for the reasons set out above.

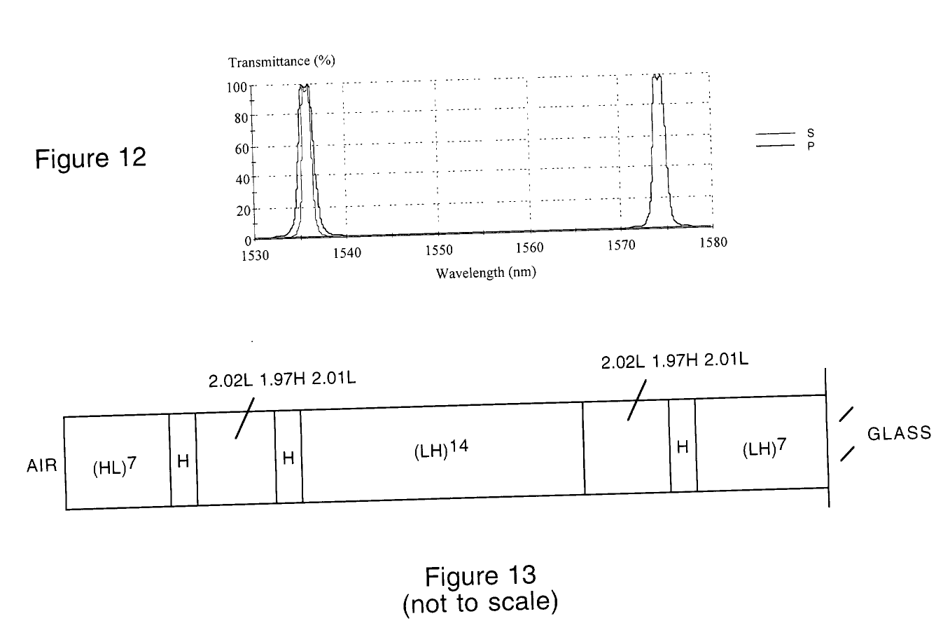

FIG. 12 is a plot of the bandpass of a third thin film filter incorporating an asymmetric partitioned cavity according to method 3, and further including a design modification to the cavity according to method 2(b). The filter prescription is:

AIR I (HL)⁷ (1.99H 3.01L) (HL)⁷(1.99H 3.01L) (HL)⁷ I GLASS

Here, the asymmetric partitioned cavity (nominally 2H 3L has been further modified according to method 2(b) to be 2−ΔH 3+ΔL, where A equals 0.01.

What is claimed is:

1. A method for designing a polarization-independent thin film optical interference filter comprising the steps of:
a) selecting an original current filter design including a plurality of low-index quarter wave layers adjacent to high index quarter wave layers (LH or HL) forming quarter wave stacks (QWS) and multiple thicknesses of low-index quarter wave layers and/or of high index quarter wave layers forming half wave cavities (HWC);
b) modifying the current filter design according to at least one of design rule 1, design rule 2, or design rule 3 to produce a modified filter design;
c) testing the current filter design to determine whether the current filter design meets a predetermined polarization-independence criterion; and
d) if the current design does not meet the criterion returning to step (b);
wherein design rule 1 includes: increasing or decreasing the thicknesses of HWC's in the filter by a small (less than ¼ wavelength) increment;
design rule 2 includes: adding small increments (less than ¼ wavelength) to one or more layers and correspondingly subtracting equivalent aggregate increments from one or more adjacent or nearby layers; and
design rule 3 includes: replacing HWC's with asymmetric composite HWC's.

2. The method of claim 1, wherein design rule 2 comprises design rules 2(a), 2(b), and 2(c) wherein:
design rule 2(a) includes—adding small increments to quarter wave layers of either high or low index characteristic, and subtracting equivalent increments from quarter wave layers of the opposite index characteristic;
design rule 2(b) includes—adding or subtracting a small increment (less than ¼ wavelength) to/from a HWC and subtracting or adding equivalent aggregate small increments to adjacent or nearby quarter wave layer or layers to compensate; and
design rule 2(c) includes—adding small increments to one or more layers of a HWC and subtracting equivalent aggregate increments from one or more layers of the HWC.

3. A method for designing a polarization-independent thin film optical interference filter comprising the steps of:
a) selecting an original current filter design including a plurality of low-index quarter wave layers adjacent to high index quarter wave layers (LH or HL) forming quarter wave stacks (QWS) and multiple thicknesses of low-index quarter wave layers and/or of high index quarter wave layers forming half wave cavities (HWC);
b) increasing or decreasing the thicknesses of HWC's in the filter by a small (less than ¼ wavelength) increment;
c) testing the current filter design to determine whether the current filter design meets a predetermined polarization-independence criterion; and
d) if the current design does not meet the criterion returning to step (b).

4. A method for designing a polarization-independent thin film optical interference filter comprising the steps of:
a) selecting an original current filter design including a plurality of low-index quarter wave layers adjacent to high index quarter wave layers (LH or HL) forming quarter wave stacks (QWS) and multiple thicknesses of low-index quarter wave layers and/or of high index quarter wave layers forming half wave cavities (HWC);
b) adding small increments (less than ¼ wavelength) to one or more layers and correspondingly subtracting equivalent aggregate increments from one or more adjacent or nearby layers;
c) testing the current filter design to determine whether the current filter design meets a predetermined polarization-independence criterion; and
d) if the current design does not meet the criterion returning to step (b).

5. The method of claim 4, wherein step(b) comprises either:
adding small increments to quarter wave layers of either high or low index characteristic, and subtracting equivalent increments from quarter wave layers of the opposite index characteristic;
adding or subtracting a small increment (less than ¼ wavelength) to/from a HWC and subtracting or adding equivalent aggregate small increments to adjacent or nearby quarter wave layer or layers to compensate; or
adding small increments to one of more layers of a HWC and subtracting equivalent aggregate increments from one or more layers of the HWC.

6. A method for designing a polarization-independent thin film optical interference filter comprising the steps of:
a) selecting an original current filter design including a plurality of low-index quarter wave layers adjacent to high index quarter wave layers (LH or HL) forming quarter wave stacks (QWS) and multiple thicknesses of low-index quarter wave layers and/or of high index quarter wave layers forming half wave cavities (HWC);
b) replacing HWC's with asymmetric composite HWC's;
c) testing the current filter design to determine whether the current filter design meets a predetermined polarization-independence criterion; and
d) if the current design does not meet the criterion returning to step (b).

7. An improved thin film interference filter based upon a filter having a plurality of low-index quarter wave layers (L) adjacent to high index quarter wave layers (H) forming quarter wave stacks (QWS) at a given wavelength and multiple thicknesses of low-index quarter wave layers and/or of high index quarter wave layers forming half wave cavities (HWC's) at the given wavelength, wherein the improvement comprises of at least one of the following variations:
a) at least one of the HWC's is replaced by a slightly thinner or thicker near-HWC at the given wavelength;
b) the QWS's are replaced by near-QWS's comprising a plurality of low-index near quarter wave layers (near-QWL's) adjacent to high index near-QWL's; wherein the thickness of the high-index near-QWL's are either slightly thickened or slightly thinned and the thickness of the low-index near-QWL's are either correspondingly slightly thinned or slightly thickened to compensate;
c) the HWC's are replaced by slightly thinner or slighter thicker near-HWC's and one or more nearby or adjacent layers are correspondingly either slightly thickened or slightly thinned to compensate;
d) small increments are added to one of more layers of a HWC and equivalent aggregate increments are subtracted from one or more layers of the HWC;
(e) HWC's are replaced by asymmetric composite HWC's having the form (2mH 2nL) or (2mL 2nH); or
(f) HWC's are replaced by asymmetric composite HWC's having the form (2mH (2n−1)L) or (2mL (2n−1)H).

8. An improved thin film interference filter based upon a filter having a plurality of low-index quarter wave layers (L) adjacent to high index quarter wave layers (H) forming quarter wave stacks (QWS) at a given wavelength and multiple thicknesses of low-index quarter wave layers and/or of high index quarter wave layers forming half wave cavities (HWC's) at the given wavelength, wherein the improvement comprises:
replacing at least one of the HWC's by a slightly thinner or thicker near-HWC at the given wavelength.

9. An improved thin film interference filter based upon a filter having a plurality of low-index quarter wave layers (L) adjacent to high index quarter wave layers (H) forming quarter wave stacks (QWS) at a given wavelength and multiple thicknesses of low-index quarter wave layers and/or of high index quarter wave layers forming half wave cavities (HWC's) at the given wavelength, wherein the improvement comprises:
adding small increments (less than ¼ wavelength) to one or more layers and correspondingly subtracting equivalent aggregate increments from one or more adjacent or nearby layers.

10. The filter of claim 10 wherein the QWS's are replaced by near-QWS's comprising a plurality of low-index near quarter wave layers (near-QWL's) adjacent to high index near-QWL's; wherein the thickness of the high-index near-QWL's are either slightly thickened or slightly thinned and the thickness of the low-index near-QWL's are either correspondingly slightly thinned or slightly thickened to compensate.

11. The filter of claim 10 wherein the HWC's are replaced by slightly thinner or slighter thicker near-HWC's and one or more nearby or adjacent layers are correspondingly either slightly thickened or slightly thinned to compensate.

12. The filter of claim 10 wherein small increments are added to one or more layers of a HWC and equivalent aggregate increments are subtracted from one or more layers of the HWC.

13. An improved thin film interference filter based upon a filter having a plurality of low-index quarter wave layers (L) adjacent to high index quarter wave layers (H) forming quarter wave stacks (QWS) at a given wavelength and multiple thicknesses of low-index quarter wave layers and/or of high index quarter wave layers forming half wave cavities (HWC's) at the given wavelength, wherein the improvement comprises:
replacing HWC's with asymmetric composite HWC's.

14. The filter of claim 13 wherein the HWC's are replaced by asymmetric composite HWC's having the form (2mH 2nL) or (2mL 2nH).

15. The filter of claim 13 wherein the HWC's are replaced by asymmetric composite HWC's having the form (2mH (2n−1)L) or (2mL (2n−1)H).
